(19) United States
(12) Patent Application Publication
(10) Pub. No.: US 2013/0236315 A1
(43) Pub. Date: Sep. 12, 2013

(54) COMPRESSOR/TURBINE ROTOR-TORQUE TRANSMISSION THROUGH HYBRID DRIVE

(71) Applicants: Rajesh Kumar, Bangalore (IN); Fernando Jorge Casanova, Simpsonville, SC (US)

(72) Inventors: Rajesh Kumar, Bangalore (IN); Fernando Jorge Casanova, Simpsonville, SC (US)

(21) Appl. No.: 13/413,075

(22) Filed: Mar. 6, 2012

(51) Int. Cl. F02C 7/00

(52) U.S. Cl. 416/198 A

(57) ABSTRACT

A torque transmission for a gas turbine rotor includes a plurality of adjacent rotating machine wheels. Each wheel includes a first flange on a first axial side and a second flange on a second axial side. The first flange has a plurality of first teeth extending around the circumference of the first flange and spaced by first slots, and the second flange has a plurality of second teeth extending around a circumference of the second flange and spaced by second slots. The first teeth of a first wheel are received in the second slots of a second, adjacent wheel to transmit torque through shear of the teeth and the first flange and the second flange are engaged to transmit torque through friction between the flanges.

The present invention relates to torque transmission in a gas-turbine rotor.

### BACKGROUND OF THE INVENTION

In a gas turbine, high pressure, high temperature combustion gas generated by burning fuel in high pressure combustion air is used for driving a turbine through which the energy of the combustion gas is converted into a mechanical output. Usually, combustion air is supplied by an axial-flow compressor driven by the turbine. Thus, usually the rotors of the axial-flow compressor and the output turbine are combined together to form an integral gas-turbine rotor. Further, the axial-flow compressor portion of the gas-turbine rotor is usually constructed by placing a number of rotor disks one next to another and by fastening the rotors in the axial direction using through-bolts. Rotor blades of the axial-flow compressor are embedded on the outer peripheries of the respective rotor disks.

Where a series of individual wheels and shafts are held together with sets of bolts extending axially through the stack, tension in the bolts squeezes the wheels and shafts together, and friction forces then allow torque to be transmitted across the interface, without relying on shear strength of the bolts. Significant variations in flange face friction factors, bolt assembly, and operation of the machine can result in substantial variation in the torque-carrying capabilities of the rotors. Continued operation at elevated temperatures can result in stress relaxation of the bolts, further degrading the torque capacity of the rotor.

Limits to the torque capability of friction drive machines are being approached with the higher temperature operation associated with newer, high compression ratio and high firing temperature machines. Further, operation with low heating value synthetic fuels (“process” fuels) increases the feasible output from a given machine, without any changes to the rotor construction. If the torque requirements on the rotor exceed the actual capabilities, wheels will slip relative to each other, typically resulting in a corkscrewed, or “cammed” rotor. Unbalance resulting from this will cause the machine to shut down due to unacceptable vibrations, and require time consuming and costly rotor teardown and reassembly.

### BRIEF DESCRIPTION OF THE INVENTION

According to one exemplary embodiment of the present invention, a torque transmission for a gas turbine rotor comprises a plurality of adjacent rotating machine wheels. Each wheel comprises a first flange on a first axial side and a second flange on a second axial side. The first flange has a plurality of first teeth extending around the circumference of the first flange and spaced by first slots, and the second flange has a plurality of second teeth extending around a circumference of the second flange and spaced by second slots. The first teeth of a first wheel are received in the second slots of a second, adjacent wheel to transmit torque through shear of the teeth and the first flange and the second flange are engaged to transmit torque through friction between the flanges.

### BRIEF DESCRIPTION OF THE DRAWINGS

FIG. 1 is a partial section view of a hybrid torque transmission according to an exemplary embodiment;

FIG. 2 is a partial section view of one portion of the hybrid torque transmission of FIG. 1;

FIG. 3 is a partial section view of the other portion of the hybrid torque transmission of FIG. 1;

FIG. 4 is a rabbet joint for centering wheels of the hybrid torque transmission;

FIG. 5 is a rabbet joint for centering wheels of the hybrid torque transmission;

FIG. 6 is a hybrid torque transmission according to another exemplary embodiment; and

FIG. 7 is a hybrid torque transmission according to another exemplary embodiment.

### DETAILED DESCRIPTION OF THE INVENTION

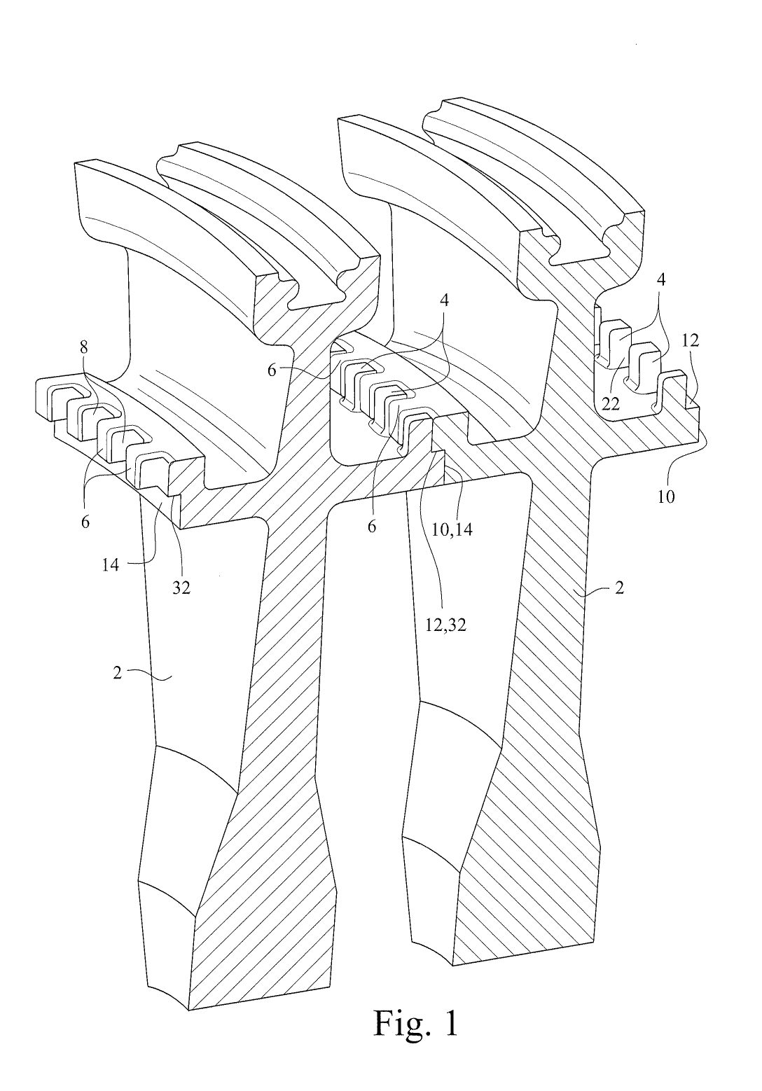

Referring to FIG. 1, a torque transmission of an axial flow compressor and/or a gas turbine includes a plurality of stages or wheels 2 which may be held together by an axial tie bolt or array of circumferentially arranged tie bolts (not shown). Each wheel 2 may be identical and only one needs to be described in detail.

The wheel 2 includes a first flange 14 extending from a first axial side (e.g. the upstream side) and including a plurality of axially extending splines or teeth 6 defining a plurality of first slots 8 between the axially extending teeth 6. The wheel 2 further includes a second flange 10 extending from a second axial side (e.g. the downstream side) and including a plurality of radially extending splines or teeth 4 defining a plurality of slots 22 between the radially extending teeth 4.

The first flange 14 includes a first centering, or rabbet, surface 32 that is configured to engage a second centering, or rabbet, surface 12 of the second flange 10 of a preceding wheel 2 when the radially extending teeth 4 of the first wheel are received in the slots 8 between the axially extending teeth 6 of the second wheel. The first centering surface 32 and the second centering surface 12 may form a rabbet joint which would assist in centering the wheels and improve the radial load capability of the transmission.

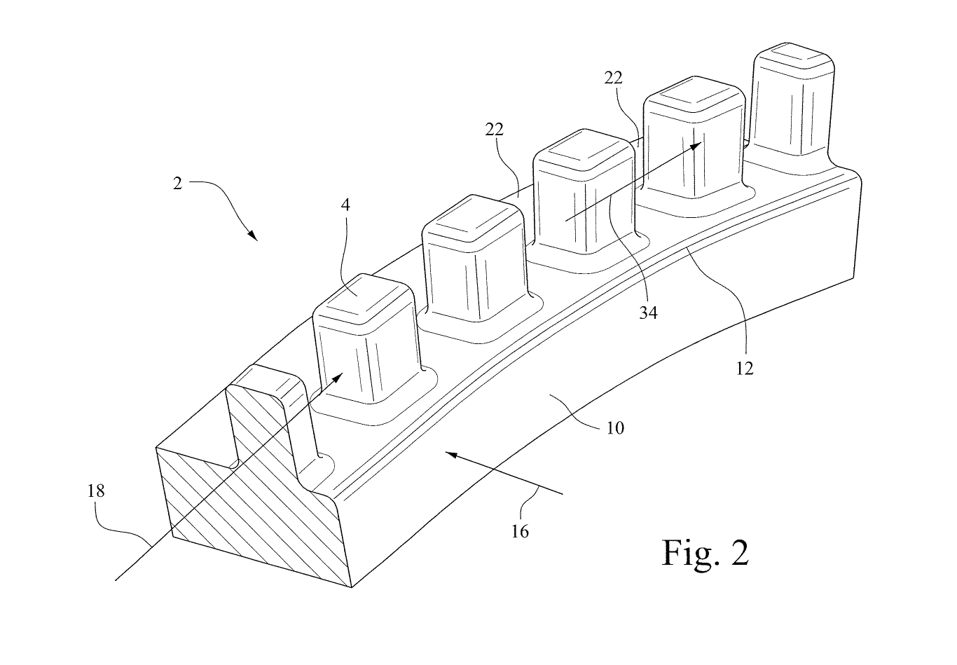

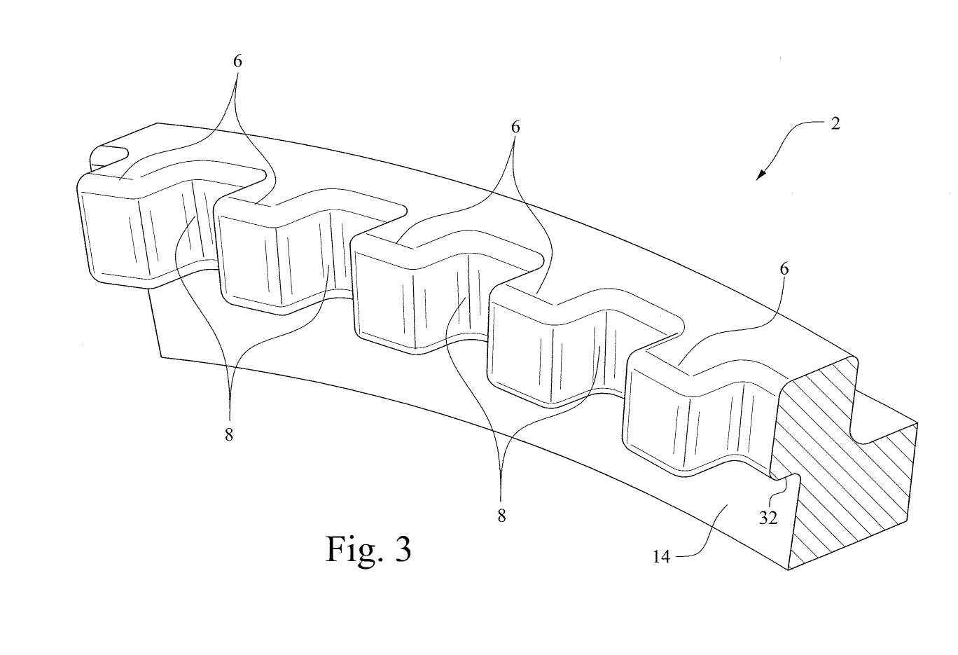

Referring to FIG. 2, the wheels are axially clamped together by a clamp load 16 provided by an axial tie bolt or array of circumferentially arranged tie bolts (not shown). A portion of the torque 18 will be transmitted by friction between the flanges 10, 14 and the remainder of the torque 18 will be transmitted through shear 34 at the radially extending teeth 4. For example, the transmission may be configured so that half of the torque 18 is transmitted through friction between the flanges 14, 10 and the other half through shear 34 through the teeth. The distribution of torque transmission may be insensitive over a range of torque loads.

The two different torque transmission mechanisms, i.e. friction and shear, aid each other. The teeth 4, 6 prevent the flanges 10, 14 from slipping and the flanges 10, 14 provide clamping to reduce, or prevent, axial separation of the teeth 4, 6. The percentage of torque 18 that is transmitted through friction between the flanges 10, 14 is determined by the clamp load 16. In general, as the clamp load 16 increases, the percentage of torque 18 that is transmitted through friction between the flanges 10, 14 increases. As a portion of the torque 18 can be transmitted by shear 34 between the teeth 4, 6, the amount of torque 18 that is transmitted through friction between the flanges 10, 14 can be reduced, and thus the clamp load 16 can be reduced. The flange crush load may also be adjusted by adjusting the area of the flanges 10, 14. The flange crush load may be reduced as the clamp load is reduced.

The number of teeth 4, 6 provided on each side of the wheel 2 may be determined in order to reduce, or minimize, any discontinuity along the circumference of the flanges 14, 10 that may tend to increase stress on the wheels 2. Leakage through the slots 8, 22 between the teeth 6, 4 may be reduced, or minimized, as radial inward or outward movement (i.e. scrubbing) of the wheels 2 is reduced by the normal load on the surface of the teeth 6, 4 due to the torque 18 and by the normal load on the flanges 14, 10 due to the clamp load 16. The reduced clamp load and reduced scrubbing results in less wear on the wheels 2.

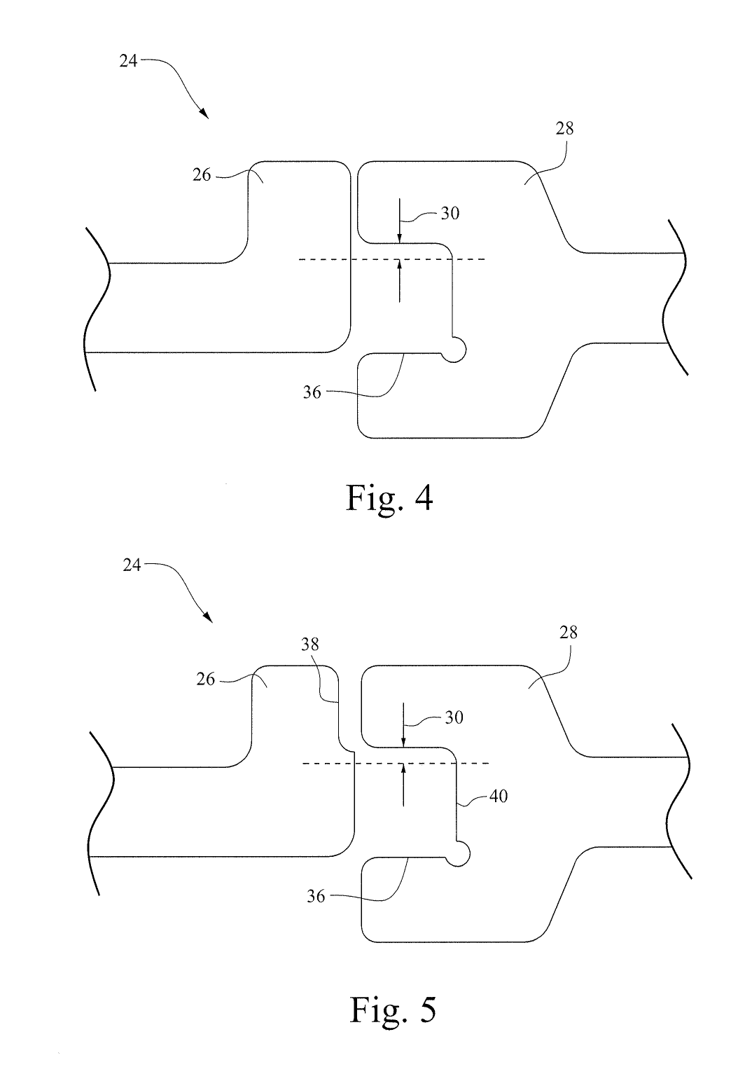

Each wheel 2 may be centered by forming the centering surface 12 as a rabbet surface, i.e. by forming a projection on the centering surface 12 configured to be received in a groove in the centering surface 32, or vise versa. Referring to FIG. 4, a separate rabbet joint 24 may be provided for centering each wheel 2 that includes an L-shaped member 26 and a C-clamp 28 including a centering, or rabbet, surface 36. The C-clamp may not require high interference with the wheel 2 and may include a gap 30. Referring to FIG. 5, the L-shaped member 26 may include a relief 38 to promote contact with a flange 40 of the C-clamp 28. It should be appreciated that a relief may be provided to the C-clamp 28.

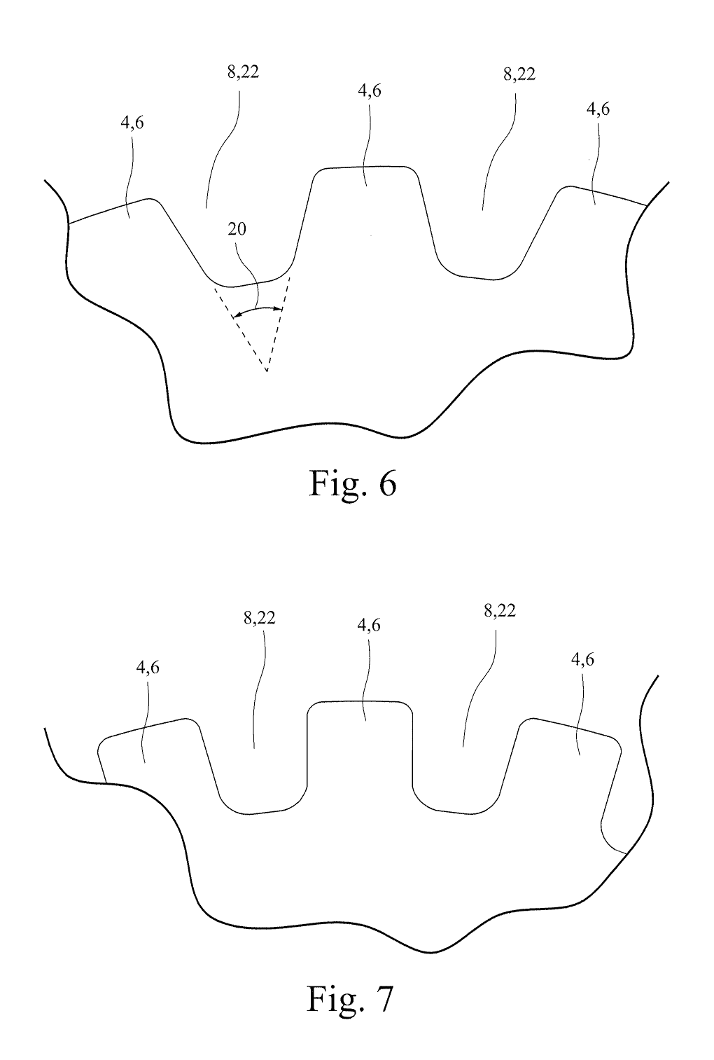

Referring to FIG. 6, the teeth 4, 6 may be formed with a flank angle 20 to eliminate rabbet surfaces 12, 32. This makes the teeth act like a birth coupling which is self centering. Referring to FIG. 7, the teeth 4, 6 may be formed so as to have parallel sides.

The wheels 2 may be held together by a bolt arrangement including a single axial tie bolt that connects all of the compressor and turbine stages or wheels, or by circumferentially arranged tie bolts. The single axial tie bolt arrangement increases the area of contact between the wheels because of the absence of holes required in the circumferentially arranged tie bolts. The unit may be assembled by press fitting the wheels with a predetermined amount of interference on the rabbet, applying a predetermined amount of torque to the wheels to pre-stress the teeth, and torquing the bolt(s).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A torque transmission for a gas turbine rotor, comprising:
a plurality of adjacent rotating machine wheels, each wheel comprising a first flange on a first axial side and a second flange on a second axial side, the first flange having a plurality of first teeth extending around the circumference of the first flange and spaced by first slots, and the second flange having a plurality of second teeth extending around a circumference of the second flange and spaced by second slots, wherein the first teeth of a first wheel are received in the second slots of a second, adjacent wheel to transmit torque through shear of the teeth and the first flange and the second flange are engaged to transmit torque through friction between the flanges.

2. A torque transmission according to claim 1, wherein the first flange and the second flange each comprise a centering surface that engage to center the first and second wheels on a center axis of the rotor.

3. A torque transmission according to claim 2, wherein the centering surfaces comprise a rabbet joint.

4. A torque transmission according to claim 3, wherein the centering surfaces engage in an interference fit.

5. A torque transmission according to claim 1, wherein the torque transmitted through friction between the flanges is determined by a clamp load applied to hold the first and second wheels together.

6. A torque transmission according to claim 5, wherein the torque transmitted through friction between the flanges increases with increasing clamp load.

7. A torque transmission according to claim 6, wherein the torque transmitted through friction between the flanges is insensitive above a predetermined clamp load.

8. A torque transmission according to claim 1, wherein the teeth comprise flank angles.

9. A torque transmission according to claim 1, further comprising a rabbet joint configured to center the first and second wheels on a center axis of the rotor.

10. A torque transmission according to claim 1, wherein the plurality of adjacent rotating machine wheels are held together by a single axial center bolt.

11. A torque transmission according to claim 1, wherein the plurality of adjacent rotating machine wheels are held together by a plurality of circumferentially arranged bolts.

12. A gas turbine rotor having an axial flow compressor and a gas turbine each including a torque transmission according to claim 1.

13. A gas turbine rotor having an axial flow compressor and a gas turbine each including a torque transmission according to claim 10.

14. A method of transmitting torque between adjacent rotating machine wheels, comprising:
transmitting torque through shear of a plurality of teeth provided on flanges of the adjacent wheels, the teeth of each wheel being received in slots between teeth of an adjacent wheel; and
transmitting torque through friction between the flanges.

15. A method according to claim 14, further comprising:
centering the wheels on an axis.

16. A method according to claim 14, further comprising:
adjusting the torque transmitted through friction by adjusting a clamping load of the wheels.

17. A method according to claim 16, wherein adjusting the transmitted torque comprises increasing the transmitted torque by increasing the clamping load.
